(19) United States
(12) Patent Application Publication
(10) Pub. No.: US 2018/0258300 A1
(43) Pub. Date: Sep. 13, 2018

(54) INK COMPOSITION AND CONTAINER

(71) Applicant: Seiko Epson Corporation, Tokyo (JP)

(72) Inventors: Yuho MIYAKE, Shiojiri (JP); Ryosuke TERAMOTO, Matsumoto (JP); Tetsuya AOYAMA, Shiojiri (JP)

(21) Appl. No.: 15/891,691

(22) Filed: Feb. 8, 2018

(30) Foreign Application Priority Data
Mar. 9, 2017 (JP) 2017-045096

(51) Int. Cl. C09D 11/324; C09D 11/322; C09D 11/033; C09D 11/107; C09D 11/102; B41J 2/175

(52) U.S. Cl. CPC C09D 11/324; C09D 11/322; C09D 11/033; B41J 2002/17516; C09D 11/102; B41J 2/17513; C09D 11/107

(57) ABSTRACT

An ink composition contains resin particles, a pigment, glycol ether, and water, wherein the resin particles satisfy the condition defined by Relational Expression (1)

1.0≤(ϕ2/ϕ1)≤12.5 (1)

(where ϕ1 represents the volume average particle size of the resin particles in a solution containing 20 mass % of the resin particles and 80 mass % of water, and ϕ2 represents the volume average particle size of the resin particles in a solution containing 90 mass % of the resin particles and 10 mass % of water).

### BACKGROUND

### 1. Technical Field

The present invention relates to an ink composition and a container.

### 2. Related Art

Ink jet recording enables highly precise recording of images with relatively simple apparatuses and has been therefore rapidly developed in a variety of fields. In this circumstance, various studies have been made to further stably produce high-quality recorded matters.

JP-A-2016-22637, for example, discloses a technique that enables a liquid container to have an appropriate size. In particular, it discloses an ink container that is capable of being attached to and detached from a liquid supplying apparatus that supplies a liquid to a liquid ejection apparatus; and the ink container includes an ink bag that includes at least two flexible films bonded so as to face each other and can contain an ink between the at least two films and a handle portion that is positioned at an end of the ink bag and that protrudes outward from the ink bag, wherein the handle portion includes an opening formed so as to pass through in a first direction that is the direction in which the at least two films face each other, the opening has a dimension ranging from 80 mm to 120 mm in a specific direction, and the ink bag has a width ranging from 50 mm to 300 mm in this specific direction.

Ink compositions containing a pigment as a colorant may contain resin particles to improve the fastness of recorded matters. In this case, the resin particles serve as a binder, and thus the pigment can be steadily fixed onto a recording medium, which enables recorded matters to have an excellent fastness.

In the case where a typical ink composition containing resin particles is used in a state in which it is held in a containing portion that is included in the liquid container disclosed in JP-A-2016-22637 and that is formed of the flexible films, the ink composition is unevenly present in the lower part of the containing portion because of gravity, which results in parts of the films adhering to each other via a small amount of the ink composition at the upper part of the containing portion of the liquid container. At the part at which parts of the films are adhering to each other, the moisture of the ink composition is absorbed by the films, and the balance between hydrophilic components of the ink composition and hydrophobic components thereof (content percentage) changes; in addition, the distance between the resin particles becomes small, and the resin particles are therefore likely to agglomerate. Thus, foreign substances derived from the resin particles may be generated in the liquid container in some cases. The generation of the foreign substances causes the resin particle content in the ink composition to be decreased, and thus excellent fastness of recorded matters becomes hard to be produced. In the case where the ink composition is ejected by an ink jet technique, such foreign substances are ejected as well. Hence, continuous printing suffers insufficient stability.

### SUMMARY

An advantage of some aspects of the invention is that there is provided an ink composition that enables production of a recorded matter having an excellent fastness even in the case where the ink composition is used in a state in which it is held in a containing portion formed of flexible films.

The inventors have intensively studied and found that an ink composition which contains resin particles, a pigment, glycol ether, and water and in which the volume average particle size D50 of the resin particles satisfies a specific relational expression enables production of a recorded matter having an excellent fastness even in the case where the ink composition is used in a state in which it is held in a containing portion formed of flexible films, thereby accomplishing the invention.

According to a first aspect of the invention, an ink composition contains resin particles, a pigment, glycol ether, and water, wherein the resin particles satisfy the condition defined by Relational Expression (1)

1.0≤(ϕ2/ϕ1)≤12.5 (1)

(where ϕ1 represents the volume average particle size D50 of the resin particles in a solution containing 20 mass % of the resin particles and 80 mass % of water, and ϕ2 represents the volume average particle size D50 of the resin particles in a solution containing 90 mass % of the resin particles and 10 mass % of water).

The mechanism in which the ink composition according to the first aspect of the invention brings the above-mentioned advantage is speculated as follows but is not limited thereto. In particular, the volume average particle size D50 of the resin particles satisfies the condition defined by Relational Expression (1) in the ink composition according to the first aspect of the invention; mainly because of this, even when parts of films are adhering to each other via a small amount of the ink composition at the upper part of the containing portion of a liquid container, impairment of dispersibility of the resin particles and agglomeration of the resin particles are reduced in the ink composition existing at the adhering parts of the films, namely in the ink composition with reduced moisture content. As a result, generation of foreign substances derived from the resin particles is reduced, so that the intended resin particle content in the ink composition can be maintained; thus, printed matters having an excellent fastness can be produced. The term “particle size” herein refers to volume average particle size.

In the ink composition according to the first aspect of the invention, it is preferable that the resin particles satisfy the condition defined by Relational Expression (2)

1.0≤(ϕ4/ϕ3)≤20 (2)

(where ϕ3 represents the volume average particle size D50 of the resin particles in a solution containing 20 mass % of the resin particles, 5 mass % of triethylene glycol monobutyl ether, and 75 mass % of water; and ϕ4 represents the volume average particle size D50 of the resin particles in a solution containing 90 mass % of the resin particles, 5 mass % of triethylene glycol monobutyl ether, and 5 mass % of water).

In the ink composition according to the first aspect of the invention, it is preferable that the pigment be a self-dispersion-type pigment that satisfies the condition defined by Relational Expression (3)

1.0≤(ϕ6/ϕ5)≤10 (3)

(where ϕ5 represents the volume average particle size D50 of the self-dispersion-type pigment in a solution containing 20 mass % of the self-dispersion-type pigment and 80 mass % of water, and ϕ6 represents the volume average particle size D50 of the self-dispersion-type pigment in a solution containing 90 mass % of the self-dispersion-type pigment and 10 mass % of water).

In the ink composition according to the first aspect of the invention, it is preferable that the glass transition temperature of the resin particles be from −50° C. to 0° C. It is preferable that the resin particles contain at least one selected from the group consisting of a (meth)acrylic resin, a urethane resin, an epoxy resin, a polyolefin resin, and a styrene acrylic resin. It is preferable that the resin particle content be from 0.5 mass % to 5.0 mass % relative to the total amount of the ink composition. It is preferable that the pigment be a carbon black pigment subjected to an ozone oxidation treatment. It is preferable that the zeta potential of the resin particles be from −60 mV to −15 mV in a solution containing 20 mass % of the resin particles and 80 mass % of water.

According to a second aspect of the invention, a container includes a containing portion formed of a flexible film and the ink composition according to the first aspect of the invention, the ink composition being held in the containing portion, wherein the water absorption rate of the film is 3% or less. In the container according to the second aspect of the invention, it is preferable that the film have two or more layers and that the two or more layers at least include a layer containing nylon.

### BRIEF DESCRIPTION OF THE DRAWINGS

The invention will be described with reference to the accompanying drawings, wherein like numbers reference like elements.

FIG. 1 is a perspective view illustrating the main structure of a printing apparatus in a second embodiment of the invention.

FIG. 2 is a perspective view illustrating an ink container according to the second embodiment of the invention.

FIG. 3 is a perspective view illustrating another ink container according to the second embodiment of the invention.

FIG. 4 is a perspective view illustrating another ink container according to the second embodiment of the invention.

FIG. 5 is a perspective view illustrating another ink container according to the second embodiment of the invention.

FIG. 6 is a perspective view illustrating a disassembled ink container according to the embodiment of the invention.

### DESCRIPTION OF EXEMPLARY EMBODIMENTS

Embodiments of the invention (hereinafter referred to as “embodiments”) will now be described in detail properly with reference to the drawings, but the invention is not limited thereto and can be variously modified without departing from the scope of the invention.

### Ink Composition

An ink composition according to a first embodiment (also simply referred to as “ink composition”) contains resin particles, a pigment, glycol ether, and water. The resin particles used in the ink composition of the first embodiment satisfy the condition defined by Relational Expression (1)

1.0≤(ϕ2/ϕ1)≤12.5 (1)

(where ϕ1 represents the volume average particle size D50 of the resin particles in a solution containing 20 mass % of the resin particles and 80 mass % of water, and ϕ2 represents the volume average particle size D50 of the resin particles in a solution containing 90 mass % of the resin particles and 10 mass % of water).

Such an ink composition enables production of a recorded matter having an excellent fastness even in the case where the ink composition is used in a state in which it is held in a containing portion formed of flexible films; the mechanism thereof is speculated as follows but is not limited thereto. In particular, the volume average particle size D50 of the resin particles satisfies the condition defined by Relational Expression (1) in the ink composition of the first embodiment; mainly because of this, even when parts of films are adhering to each other via a small amount of the ink composition at the upper part of the containing portion of a liquid container, impairment of dispersibility of the resin particles is reduced in the ink composition existing at the adhering parts of the films, namely in the ink composition with reduced moisture content. As a result, generation of foreign substances is reduced, so that printed matters having an excellent fastness can be produced. In addition, such a reduction in generation of foreign substances enables continuous printing, in which the ink composition is ejected by an ink jet technique, to be highly stable.

### Resin Particles

The resin particles used in the first embodiment (also referred to as “resin dispersion” or “resin emulsion”) are particles containing resin. The resin particles used in the first embodiment satisfy the condition defined by Relational Expression (1)

1.0≤(ϕ2/ϕ1)≤12.5 (1)

(where ϕ1 represents the volume average particle size D50 of the resin particles in a solution containing 20 mass % of the resin particles and 80 mass % of water, and ϕ2 represents the volume average particle size D50 of the resin particles in a solution containing 90 mass % of the resin particles and 10 mass % of water).

The (ϕ2/ϕ1) is preferably from 1.0 to 11, more preferably from 1.0 to 10, and further preferably from 5.0 to 10.

The resin particles used in the first embodiment preferably satisfy the condition defined by Relational Expression (2). This is likely to contribute to further enhancements in the fastness of printed matters and the stability of continuous printing

1.0≤(ϕ4/ϕ3)≤20 (2)

(where ϕ3 represents the volume average particle size D50 of the resin particles in a solution containing 20 mass % of the resin particles, 5 mass % of triethylene glycol monobutyl ether, and 75 mass % of water; and ϕ4 represents the volume average particle size D50 of the resin particles in a solution containing 90 mass % of the resin particles, 5 mass % of triethylene glycol monobutyl ether, and 5 mass % of water).

The (ϕ4/ϕ3) is preferably from 1.0 to 18, more preferably from 1.0 to 16, and further preferably from 10 to 16.

The volume average particle size D50 of the resin particles can be herein measured in the manner that will be described later in Examples.

The resin particles used in the first embodiment may be self-dispersion-type resin particles to which a hydrophilic component necessary for stable dispersion in water has been introduced or resin particles which can be dispersed in water with the aid of an external emulsifier. The resin particles are preferably a self-emulsion-type resin dispersion because it does not inhibit the reaction with a polyvalent metal compound that can be contained in a recording medium that will be described later.

Examples of the resin include (meth)acrylic resins, urethane resins, epoxy resins, polyolefin resins, styrene acrylic resins, fluorene resins, rosin-modified resins, terpene resins, polyester resins, polyamide resins, vinyl chloride resins, vinyl chloride-vinyl acetate copolymers, and ethylene-vinyl acetate resins. In particular, the resin is preferably at least one selected from the group consisting of (meth)acrylic resins, urethane resins, epoxy resins, polyolefin resins, and styrene acrylic resins; and more preferably at least one selected from the group consisting of urethane resins and styrene acrylic resins. These resins may be used alone or in combination.

The term “(meth)acrylic resins” refers to resins having a (meth)acrylic skeleton. Examples of the (meth)acrylic resins include, but are not limited to, polymers of (meth)acrylic monomers, such as (meth)acrylic acids and (meth)acrylates, and copolymers of (meth)acrylic monomers with other monomers. Examples of such other monomers include vinyl monomers such as styrene. The term “(meth)acryl” herein comprehensively refers to both “methacryl” and “acryl”.

Examples of the urethane resins include polyether urethane resins, polyester urethane resins, and polycarbonate urethane resins having an ether linkage, an ester linkage, and a carbonate linkage on the main chains thereof as well as urethane linkage, respectively. Among these, polyester urethane resins having an ester linkage on the main chain thereof are preferred. These urethane resins may be used alone or in combination.

Examples of commercially available products of the urethane resins include UW-1501F and UW-5002 (tradenames, manufactured by Ube Industries, Ltd.); W-6061 and W-6110 (tradenames, manufactured by Mitsui Chemicals, Inc.); and UX-150, UX-390, and UX-200 (tradenames, manufactured by Sanyo Chemical Industries, Ltd.).

Examples of the styrene acrylic resins include copolymers of aromatic vinyl monomers, such as styrene, α-methylstyrene, vinyl toluene, 4-t-butylstyrene, chlorostyrene, vinyl anisole, and vinyl naphthalene, with the above-mentioned monomers used in (meth)acrylic resins; and known resins can be appropriately used. In particular, styrene acrylic resins that will be described later in Examples are preferred.

The zeta (ζ) potential of the resin particles in a solution containing 20 mass % of the resin particles and 80 mass % of water is preferably from −60 mV to −15 mV, more preferably from −57 mV to −17 mV, and further preferably from −55 mV to −20 mV. At zeta (ζ) potential of the resin particles in such a range, the resin particles are more likely to electrically repel each other, so that generation of foreign substances is reduced; hence, the fastness of printed matters and the stability of continuous printing are likely to be further enhanced.

Zeta (ζ) potential can be herein measured, for example, with “Zetasizer 3000HS” manufactured by Malvern Instruments Ltd.

The glass transition temperature (Tg) of the resin particles is preferably from −50° C. to 0° C., more preferably from −35° C. to −5.0° C., further preferably from −20° C. to −5° C., and especially preferably from −20° C. to −10° C. At a glass transition temperature (Tg) of the resin particles in such a range, the fastness of printed matters and the stability of continuous printing are likely to be further enhanced. Glass transition temperature can be measured by any of known techniques. It can be, for instance, measured with a differential scanning calorimeter “DSC7000” manufactured by Hitachi High-Tech Science Corporation in accordance with JIS K 7121 (Testing Methods for Transition Temperatures of Plastics).

In the ink composition, the resin particle content (on a solid basis) is preferably in the range of 0.1 mass % to 10 mass %, more preferably 0.5 mass % to 5.0 mass %, and further preferably 1.0 mass % to 4.0 mass % relative to the total amount of the ink composition (100 mass %). At a resin particle content in such a range, the fastness of printed matters and the stability of continuous printing are likely to be further enhanced.

### Pigment

The pigment used in the first embodiment is not particularly limited but preferably a self-dispersion-type pigment. Self-dispersion-type pigments are pigments each having a hydrophilic group on its surface. A preferred hydrophilic group is at least one hydrophilic group selected from the group consisting of —OM, —COOM, —CO—, —SO₃M, —SO₂M, —SO₂NH₂, —RSO₂M, —PO₃HM, —PO₃M₂, —SO₂NHCOR, —NH₃, and —NR₃.

In these chemical formulae, M represents a hydrogen atom, alkali metal, ammonium, a phenyl group optionally having a substituent, or organic ammonium; and R represents an alkyl group having 1 to 12 carbon atoms or a naphthyl group optionally having a substituent. M and R are each independently selected.

Specifically, a pigment is subjected to a physical treatment and/or a chemical treatment in order to bond (graft) any of the above-mentioned hydrophilic groups to the surface of the pigment, thereby preparing a self-dispersion-type pigment. A specific example of the physical treatment is a vacuum plasma treatment. Specific examples of the chemical treatment include a wet oxidation process that involves oxidation with an oxidant in water and a process in which p-aminobenzoic acid is bonded to the surface of a pigment to bond a carboxyl group via a phenyl group. In particular, the pigment is preferably carbon black subjected to an ozone oxidation treatment or a phosphorylation treatment, and especially preferably carbon black subjected to an ozone oxidation treatment.

The self-dispersion-type pigment preferably satisfies the condition defined by Relational Expression (3). This enables a reduction in generation of foreign substances due to use of the self-dispersion-type pigment, so that the fastness of printed matters and the stability of continuous printing are likely to be further enhanced

1.0≤(ϕ6/ϕ5)≤10 (3)

(where ϕ5 represents the volume average particle size D50 of the self-dispersion-type pigment in a solution containing 20 mass % of the self-dispersion-type pigment and 80 mass % of water, and ϕ6 represents the volume average particle size D50 of the self-dispersion-type pigment in a solution containing 90 mass % of the self-dispersion-type pigment and 10 mass % of water).

The (ϕ6/ϕ5) is preferably from 1.0 to 8.0, more preferably from 1.0 to 6.5, and especially preferably from 3.0 to 6.5.

The volume average particle size D50 of the self-dispersion-type pigment can be herein measured in the manner that will be described later in Examples.

In the ink composition, the pigment particle content is preferably in the range of 1.0 mass % to 20 mass %, more preferably 3.0 mass % to 15 mass %, and further preferably 5.0 mass % to 10 mass % relative to the total amount of the ink composition (100 mass %). At a pigment particle content in such a range, the fastness of printed matters and the stability of continuous printing are likely to be further enhanced.

### Water

The ink composition of the first embodiment contains water. Examples of the water include water obtained by removing ionic impurities as many as possible, for instance, pure water, such as ion exchanged water, ultra-filtration water, reverse osmosis water, and distilled water, and ultrapure water. In addition, use of water sterilized by being irradiated with ultraviolet or adding hydrogen peroxide enables generation of mold or bacteria to be prevented in long-term storage of a condensate. Accordingly, storage stability is likely to be improved.

### Organic Solvent

The ink composition of the first embodiment contains glycol ether. Any glycol ether can be used provided that it can be used along with water. Furthermore, an organic solvent other than glycol ether can be additionally used. Examples of such an organic solvent other than glycol ether include cyclic nitrogen compounds, aprotic polar solvents, monoalcohols, and alkylpolyols (for instance, glycerin).

Examples of glycol ether include, but are not limited to, glycol diethers and glycol monoethers.

Specific examples of glycol diethers include, but are not limited to, ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Examples of the glycol monoether include, but are not limited to, ethylene glycol monomethyl ether, ethylene glycol monoethyl ether, ethylene glycol mono-n-propyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

The glycol ether content is preferably in the range of 0.1 mass % to 30 mass %, more preferably 0.5 mass % to 10 mass %, and further preferably 1.0 mass % to 5.0 mass % relative to the total amount of the ink composition (100 mass %). At a glycol ether content in such a range, the fastness of printed matters and the stability of continuous printing are likely to be further enhanced.

### Surfactant

The ink composition preferably further contains a surfactant in terms of the stability of continuous printing. Examples of the surfactant include, but are not limited to, acetylenic glycol surfactants, fluorochemical surfactants, and silicone surfactants.

The acetylene glycol surfactants are not particularly limited but preferably at least one selected from 2,4,7,9-tetramethyl-5-decyne-4,7-diol, alkylene oxide adducts of 2,4,7,9-tetramethyl-5-decyne-4,7-diol, 2,4-dimethyl-5-decyne-4-ol, and alkylene oxide adducts of 2,4-dimethyl-5-decyne-4-ol. Commercially available products of the acetylene glycol surfactants are not particularly limited; examples thereof include OLFINE 104 series and E series such as OLFINE E1010 (tradenames, manufactured by Air Products Japan, Inc.) and Surfynol 104PG50, 465, 61, and DF110D (tradenames, manufactured by Nissin Chemical Industry Co., Ltd.). The acetylene glycol surfactants may be used alone or in combination.

The fluorochemical surfactants are not particularly limited; examples thereof include perfluoroalkyl sulfonates, perfluoroalkyl carboxylates, perfluoroalkyl phosphoric acid esters, perfluoroalkyl ethylene oxide adducts, perfluoroalkyl betaine, and perfluoroalkyl amine oxide compounds. Commercially available products of the fluorochemical surfactants are not particularly limited; examples thereof include S-144 and S-145 (tradenames, manufactured by Asahi Glass Co., Ltd.); FC-170C, FC-430, and Fluorad-FC4430 (tradenames, manufactured by Sumitomo 3M Limited); FSO, FSO-100, FSN, FSN-100, and FS-300 (tradenames, manufactured by E.I. du Pont de Nemours and Company); and FT-250 and 251 (tradenames, manufactured by NEOS COMPANY LIMITED). The fluorochemical surfactants may be used alone or in combination.

Examples of the silicone surfactants include, but are not limited to, polysiloxane compounds and polyether-modified organosiloxane. Specific examples of commercially available products of the silicone surfactants include, but are not limited to, SAG503A (tradename, manufactured by Nissin Chemical Industry CO., Ltd.); BYK-306, BYK-307, BYK-333, BYK-341, BYK-345, BYK-346, BYK-347, BYK-348, and BYK-349 (tradenames, manufactured by BYK Additives & Instruments); and KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (tradenames, manufactured by Shin-Etsu Chemical Co., Ltd.). The silicone surfactants may be used alone or in combination.

The surfactant content is preferably in the range of 0.05 mass % to 2.5 mass %, and more preferably 0.05 mass % to 1.5 mass % relative to the total amount of the ink composition (100 mass %). At a surfactant content in such a range, the fastness of printed matters and the stability of continuous printing are likely to be further enhanced.

The ink composition may further appropriately contain a variety of additives as other components, such as a softener, wax, a dissolution aid, a viscosity modifier, a pH adjuster such as tri-isopropanolamine, a humectant, an antioxidant, an antifungal agent and preservative, fungicide, a corrosion inhibitor, and a chelating agent for capturing metal ions that affect dispersion (for instance, sodium ethylenediaminetetraacetic acid).

### Container

A container according to a second embodiment includes a containing portion formed of flexible films and the above-mentioned ink composition held in the containing portion. The water absorption rate of the films is 3% or less. Even in the case where parts of the films are adhering to each other, a water absorption rate of the films in such a range contributes to a reduction in absorption of the moisture from the ink composition existing at the adhering parts, so that foreign substances are less likely to be generated.

In the container, it is preferred that the films each have two or more layers and that these layers each at least include a layer containing nylon because such a layer tends to serve to easily control the water absorption rate of the films to be in the above-mentioned range. The layer structure and material of the films are not particularly limited; for instance, the container may be in the form of an ink container that will be described later.

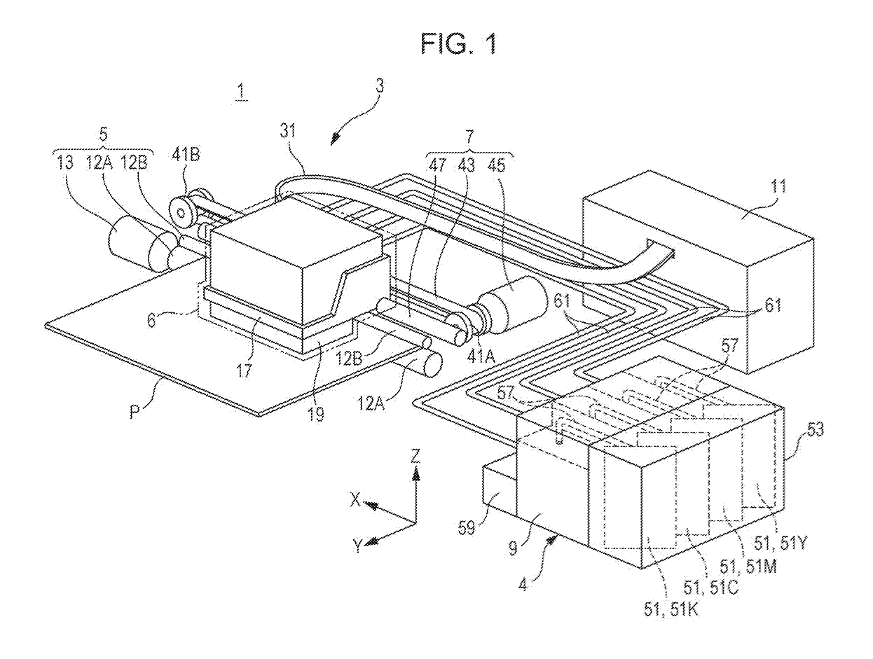

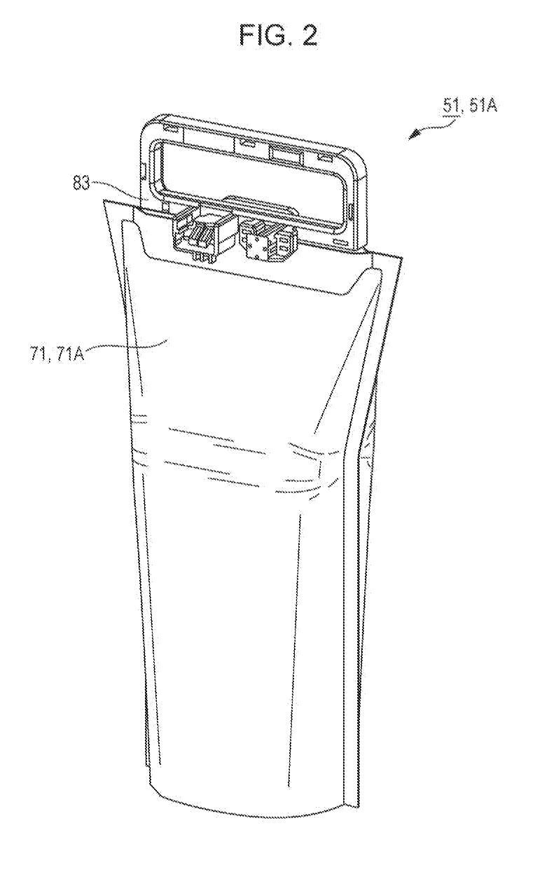

Examples of the container according to the second embodiment will now be described on the basis of a printing system illustrated in FIG. 1 and containers illustrated in FIGS. 2 to 6; however, the container according to the second embodiment is not limited to the printing system illustrated in FIG. 1 and the containers illustrated in FIGS. 2 to 6 and may have an appropriate structure.

With reference to FIG. 1, a printing system in the second embodiment includes a printer 3, which is an example of a printing apparatus, and an ink supplying apparatus 4. The printer 3 includes a transporting device 5, a recording portion 6, a moving device 7, a transmitting device 9, and a control portion 11. Note that X, Y and Z axes are shown on FIG. 1 as coordinate axes that are orthogonal to each other. The subsequent drawings may also show X, Y and Z axes if needed. In the second embodiment, a printing system 1 is used in a state in which it is disposed on a horizontal plane (X-Y plane) defined by the X axis and the Y axis. The Z axis is an axis orthogonal to the horizontal plane. In the state in which the printing system 1 is used, +Z axis direction serves as the vertically upward direction. In addition, in the state in which the printing system 1 is used, −Z axis direction serves as the vertically downward direction in FIG. 1. The directions in which the arrows of the X, Y, and Z axes point each indicate the positive (+) direction, and the direction opposite to this positive direction indicates the negative (−) direction.

The transporting device 5 intermittently transports a recording medium P, such as recording paper, in the Y axis direction. The recording portion 6 performs printing on the recording medium P transported by the transporting device 5 with the ink composition. The moving device 7 reciprocates the recording portion 6 along the X axis. The ink supplying apparatus 4 supplies the ink composition to the recording portion 6 via the transmitting device 9. The transmitting device 9 is provided between the ink supplying apparatus 4 and the recording portion 6 and transmits the ink composition, which has been supplied from the ink supplying apparatus 4, to the recording portion 6. The control portion 11 controls the driving of these components.

With reference to FIG. 1, the transporting device 5 includes a driving roller 12A, a driven roller 12B, and a transporting motor 13. The driving roller 12A and the driven roller 12B are capable of rotating in a state in which their circumferences are in contact with each other. The transporting motor 13 generates motive power for rotationally driving the driving roller 12A. The motive power from the transporting motor 13 is transmitted to the driving roller 12A via a power transmission mechanism. Then, the recording medium P pinched between the driving roller 12A and the driven roller 12B is intermittently transported in the Y axis direction.

The recording portion 6 includes a carriage 17 and a recording head 19. The recording head 19 ejects the ink composition being in the form of ink droplets to perform recording on the recording medium P. The carriage 17 has the recording head 19. The recording head 19 is connected to the control portion 11 via a flexible cable 31. The ejection of ink droplets from the recording head 19 is controlled by the control portion 11.

With reference to FIG. 1, the moving device 7 includes a timing belt 43, a carriage motor 45, and a guide shaft 47. The timing belt 43 is held under tension between a pair of pulleys 41A and 41B. The pair of pulleys 41A and 41B are aligned along the X axis. The timing belt 43 is therefore held under tension along the X axis. The carriage motor 45 generates motive power for rotationally driving the pulley 41A. The guide shaft 47 extends along the X axis. The guide shaft 47 has two ends supported by a housing (not illustrated) and guides the carriage 17 along the X axis.

The carriage 17 is fixed to a part of the timing belt 43. The carriage 17 receives the motive power transmitted from the carriage motor 45 via the pulley 41A and the timing belt 43. The carriage 17 can therefore reciprocally move along the X axis by the transmitted motive power.

With reference to FIG. 1, the ink supplying apparatus 4 includes ink containers 51, which are each an example of the container, and a case 53. In the second embodiment, the ink supplying apparatus 4 includes multiple (four in this case) ink containers 51. The four ink containers 51 are held in the case 53. The four ink containers 51 individually contain different types of ink composition. In the second embodiment, yellow (Y), magenta (M), cyan (C), and black (K) ink compositions are separately contained in the individual ink containers 51. The case 53 is provided with a detachable unit (not illustrated) to support each of the ink containers 51. The four ink containers 51 are detachably supported by the detachable unit. Each of the ink containers 51 has an ink bag that serves as the containing portion. The ink composition is hermetically confined in the ink bag formed of flexible films. In the case where the printing system 1 runs out of the ink composition held in the ink bag, the ink container 51 having this ink bag is replaced with a new one.

Ink supplying tubes 57 are individually connected to the ink bags of the ink containers 51 via the detachable unit (not illustrated). The ink supplying tubes 57, which are an example of a flow channel member, extend from the ink supplying apparatus 4 and are connected to the transmitting device 9. The transmitting device 9 includes a pump unit 59. The pump unit 59 pumps up the ink compositions held in the ink containers 51 attached to the ink supplying apparatus 4. Then, the pump unit 59 sends the ink compositions pumped up from the ink containers 51 to the recording head 19 via ink supplying tubes 61. Through this process, the ink compositions held in the ink containers 51 are supplied from the ink supplying apparatus 4 to the recording head 19 via the transmitting device 9. Then, the ink compositions supplied to the recording head 19 are ejected in the form of ink droplets through nozzles (not illustrated) pointed toward the recording medium P.

In the printing system 1 having such a structure, the driving of the transporting motor 13 is controlled by the control portion 11 to cause the transporting device 5 to intermittently transport the recording medium P in the Y axis direction such that the recording medium P faces the recording head 19. At this time, the control portion 11 controls the driving of the recording head 19 to cause ink droplets to be ejected at a predetermined position while the driving of the carriage motor 45 is controlled to reciprocate the carriage 17 along the X axis. Through this operation, dots are formed on the recording medium P, and printing is performed on the recording medium P on the basis of recording information such as image data.

With reference to FIG. 2, the ink container 51, for example, includes an ink bag 71, which is an example of the containing portion, and a flow channel unit 83. In the second embodiment, different types (four types) of ink container 51 are given as examples. The four types of ink container 51 will be hereinafter individually referred to as “ink container 51A”, “ink container 51B”, “ink container 51C”, and “ink container 51D” for the sake of distinction between them. The four types of ink container 51 are different from each other in the structure and dimension of the ink bag 71.

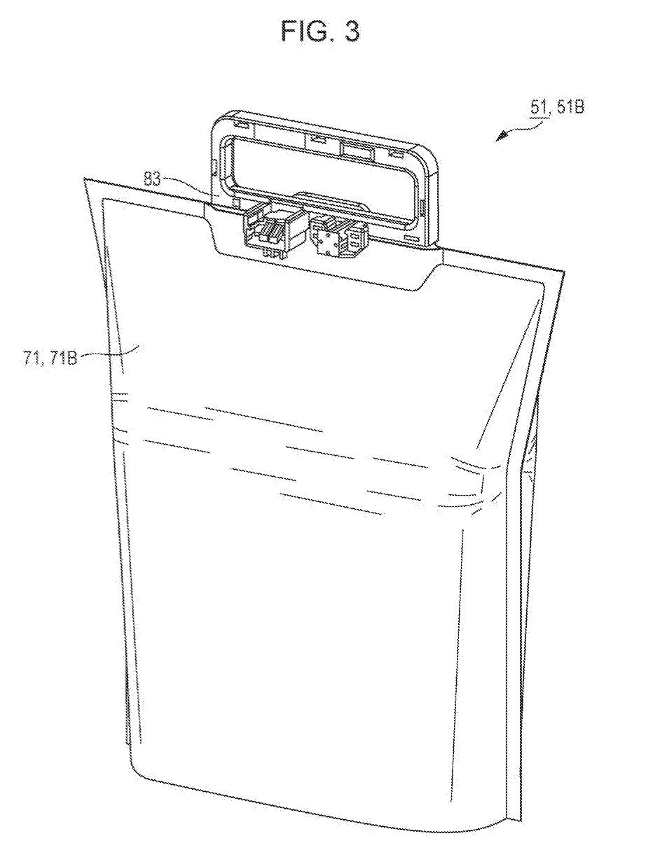

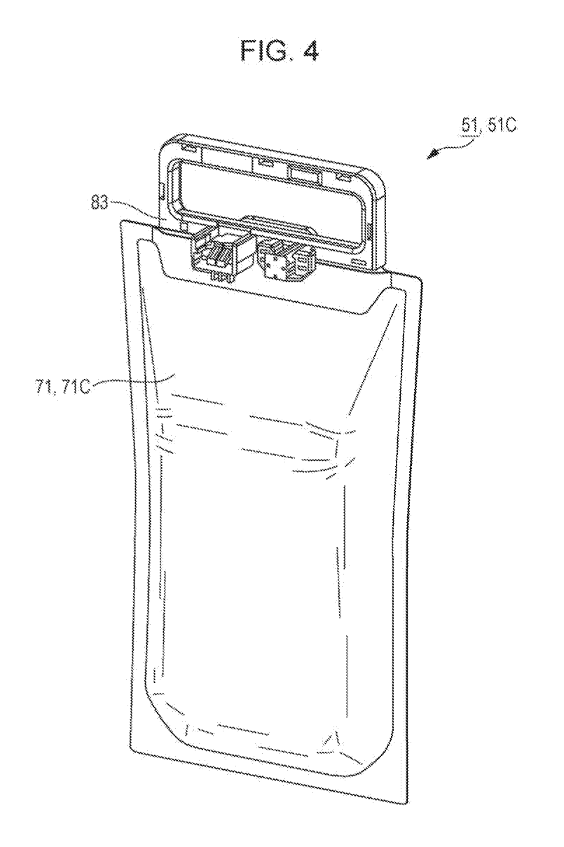

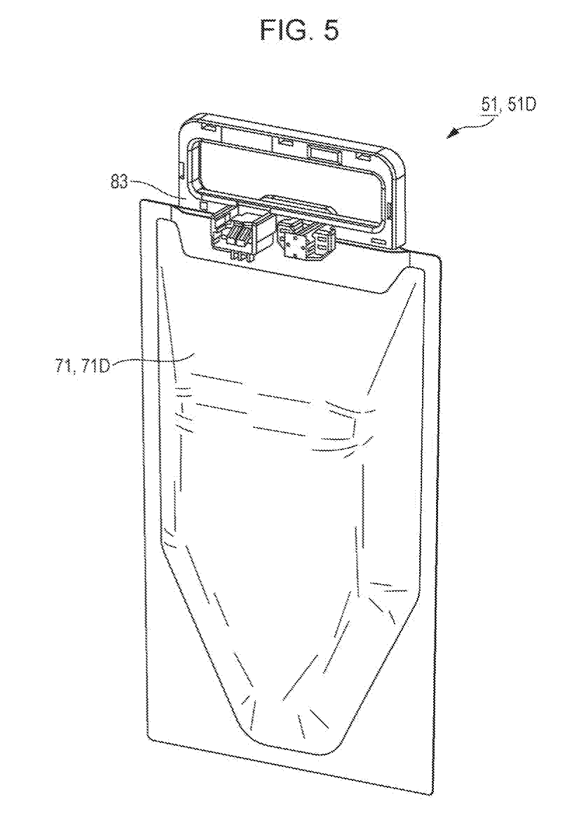

With reference to FIG. 2, the ink container 51A includes an ink bag 71A and the flow channel unit 83. With reference to FIG. 3, the ink container 51B includes an ink bag 71B and the flow channel unit 83. With reference to FIG. 4, the ink container 51C includes an ink bag 71C and the flow channel unit 83. With reference to FIG. 5, the ink container 51D includes an ink bag 71D and the flow channel unit 83. The four types of ink container 51 have the same structure except for the ink bags 71. Accordingly, the structure of the ink container 51A will now be described in detail as an example, and description of the ink containers 51B to 51D is omitted.

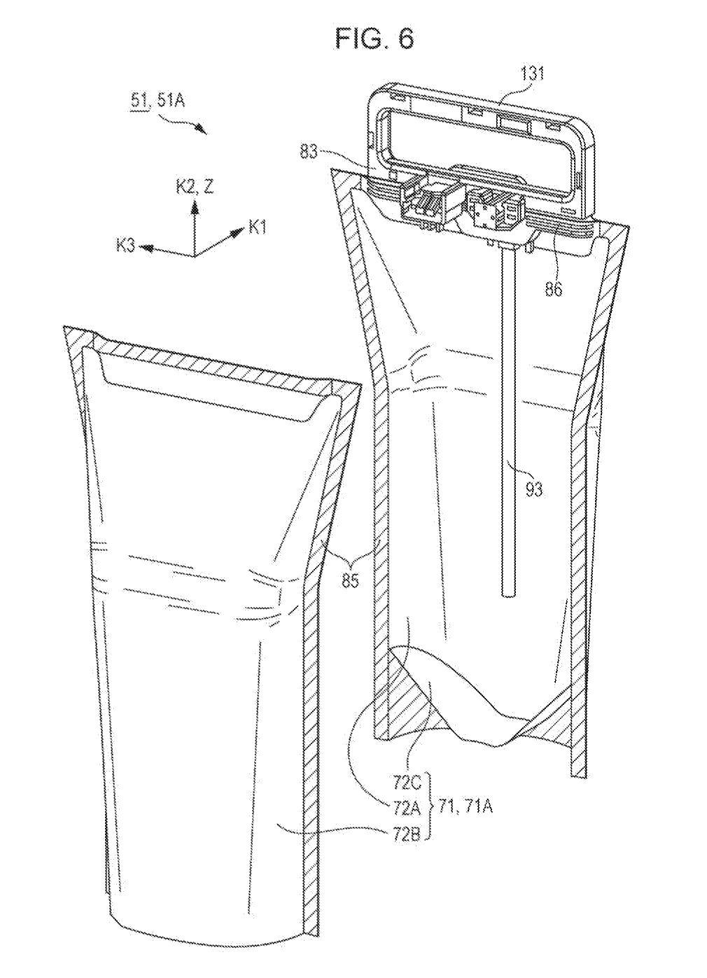

With reference to FIG. 6, the ink bag 71 includes at least two flexible film materials 72 (film material 72A and film material 72B). The ink bag 71A is composed of three film materials 72 bonded to each other. The three film materials 72 will be hereinafter individually referred to as “film material 72A”, “film material 72B”, and “film material 72C” for the sake of distinction between them. The film material 72A and the film material 72B are bonded so as to face each other. In the ink container 51, the direction in which the two film materials 72 (film material 72A and film material 72B) face each other is referred to as “first direction K1”. The direction in which a handle portion 131 of the flow channel unit 83 protrudes from the ink bag 71 is referred to as “second direction K2”. In the printing system 1, the second direction K2 corresponds to the Z axis direction. In addition, the direction that (orthogonally) crosses both the first direction K1 and the second direction K2 is referred to as “third direction K3”.

The film material 72A and the film material 72B are fused to each other at their peripheral regions 85 so as to align with each other. The film material 72C is interposed between the film material 72A and the film material 72B in the first direction K1. The periphery of the film material 72C is fused to the film material 72A and the film material 72B so as to align with the peripheral regions 85 thereof. Accordingly, the ink bag 71 is in the form of a bag having the film material 72C as the bottom. The ink bag 71 contains an ink composition. The ink bag 71 therefore functions as an ink containing portion for containing an ink composition that is an example of a liquid. In FIG. 6, the peripheral regions 85 are indicated by hatching for the sake of clear illustration of the structure thereof. In addition, FIG. 6 illustrates a state in which the film material 72C has been cut between the film material 72A and the film material 72B.

In use of such an ink bag 71, even when the ink composition is consumed, gas or another substance is not newly supplied to the inside of the ink bag 71; hence, the amount of the ink composition contained in the ink bag 71 is simply reduced. As a result, the reduced amount of the ink composition is unevenly present in the lower part of the ink bag 71, while parts of the film materials 72A and 72B are adhering to each other at the upper part of the ink bag 71. In the second embodiment, even in the case where parts of the film materials 72A and 72B of the ink bag 71 are adhering to each other, generation of foreign substances are reduced, which enables production of printed matters having an excellent fastness.

Particularly in the case where the ink bag 71 has a large size, larger parts of the film materials 72A and 72B adhere to each other at the upper part of the ink bag 71, which is likely to cause a larger amount of foreign substances to be generated. Furthermore, in the case where the ink bag 71 has a large size, it takes a relatively longer duration of time to consume the ink composition contained in the ink bag 71; thus, parts of the film materials 72A and 72B adhere to each other at the upper part of the ink bag 71 for a longer duration of time, which is likely to cause a larger amount of foreign substances to be generated.

The flow channel unit 83 is disposed between the film material 72A and the film material 72B at a part of the peripheral region 85. At that part of the peripheral region 85, the flow channel unit 83 and the film material 72A are fused to each other. Likewise, at that part of the peripheral region 85, the flow channel unit 83 and the film material 72B are fused to each other. Accordingly, the part of the peripheral region 85 at which the flow channel unit is disposed between the film material 72A and the film material 72B serves as a bonding portion between the ink bag 71 and the flow channel unit 83. The flow channel unit 83 has a fusing portion 86. The film material 72A and the film material 72B are fused to the fusing portion 86 in a state in which the fusing portion 86 is disposed between the film material 72A and the film material 72B. The film material 72A, the film material 72B, and the flow channel unit 83 are bonded to each other, thereby forming the ink bag 71 having the film material 72C as the bottom.

The film material 72A, the film material 72B, and the film material 72C can be formed of materials such as polyethylene terephthalate (PET), nylon, polyethylene, polypropylene, polyimide, cellophane, polyester, acetate, and polyamide imide. A layered structure may be employed, in which films formed of such materials are laminated. The layered structure may include, for example, an outer layer formed of PET or nylon, which has an excellent impact resistance and low water absorption rate, and an inner layer formed of polyethylene, which has an excellent ink resistance. Moreover, a film having a layer formed by vapor deposition using, for example, aluminum can be used. Such a structure enables control of the water absorption rate of the films and an enhancement in gas barrier properties thereof. The ink bag 71B of the ink container 51B (FIG. 3) is composed of three film materials 72 as in the ink bag 71A. The ink bag 71A and the ink bag 71B are in the form of a so-called “pouch type”. In the two ink containers 51C and 51D (FIGS. 4 and 5), the ink bags 71 are each composed of two film materials 72 (film material 72A and film material 72B). The two ink bags 71C and 71D are in the form of a so-called “pillow type”.

### EXAMPLES

The invention will now be further specifically described with reference to Examples. The invention is not limited to Examples at all.

### Production Example 1: Resin Particles 1

Into a reaction vessel equipped with a stirrer, a reflux condenser, a dropping device, and a thermometer, 900 g of ion exchanged water and 3 g of sodium lauryl sulfate were put. The content was heated to 70° C. under stirring while the inside of the reaction vessel was purged with nitrogen. Then, 4 g of potassium persulfate as a polymerization initiator was added thereto and dissolved while the internal temperature was maintained to be 70° C.; and an emulsion preliminarily prepared by adding 20 g of acrylamide, 300 g of styrene, 640 g of butylacrylate, and 30 g of methacrylic acid to 450 g of ion exchanged water and 3 g of sodium lauryl sulfate under stirring was subsequently continuously dropped to the reaction solution over 4 hours. After the dropping, the resulting product was aged over three hours. The resulting aqueous emulsion was cooled to normal temperature, and then ion exchanged water and an aqueous solution of 5% sodium hydroxide were added thereto to adjust the solid content and a pH level to be 40 mass % and 8, respectively. The resulting aqueous emulsion, which served as resin particles 1, had a zeta potential of −23 mV.

### Production Example 2: Resin Particles 2

Into a reaction vessel equipped with a stirrer, a reflux condenser, a dropping device, and a thermometer, 900 g of ion exchanged water and 1 g of sodium lauryl sulfate were put. The content was heated to 70° C. under stirring while the inside of the reaction vessel was purged with nitrogen. Then, 4 g of potassium persulfate as a polymerization initiator was added thereto and dissolved while the internal temperature was maintained to be 70° C.; and an emulsion preliminarily prepared by adding 20 g of acrylamide, 365 g of styrene, 545 g of butylacrylate, and 30 g of methacrylic acid to 450 g of ion exchanged water and 3 g of sodium lauryl sulfate under stirring was subsequently continuously dropped to the reaction solution over 4 hours. After the dropping, the resulting product was aged over three hours. The resulting aqueous emulsion was cooled to normal temperature, and then ion exchanged water and an aqueous solution of sodium hydroxide were added thereto to adjust the solid content and a pH level to be 40 mass % and 8, respectively. The resulting aqueous emulsion, which served as resin particles 2, had a zeta potential of −53 mV.

### Production Example 3: Resin Particles 4

Into a reaction vessel equipped with a stirrer, a reflux condenser, a dropping device, and a thermometer, 900 g of ion exchanged water and 1 g of sodium lauryl sulfate were put. The content was heated to 70° C. under stirring while the inside of the reaction vessel was purged with nitrogen. Then, 4 g of potassium persulfate as a polymerization initiator was added thereto and dissolved while the internal temperature was maintained to be 70° C.; and an emulsion preliminarily prepared by adding 20 g of acrylamide, 615 g of styrene, 295 g of butylacrylate, and 30 g of methacrylic acid to 450 g of ion exchanged water and 3 g of sodium lauryl sulfate under stirring was subsequently continuously dropped to the reaction solution over 4 hours. After the dropping, the resulting product was aged over three hours. The resulting aqueous emulsion was cooled to normal temperature, and then ion exchanged water and an aqueous solution of sodium hydroxide were added thereto to adjust the solid content and a pH level to be 40 mass % and 8, respectively. The resulting aqueous emulsion, which served as resin particles 4, had a zeta potential of −5 mV.

### Production Example 4: Resin Particles 5

Into a reaction vessel equipped with a stirrer, a reflux condenser, a dropping device, and a thermometer, 900 g of ion exchanged water and 3 g of sodium lauryl sulfate were put. The content was heated to 70° C. under stirring while the inside of the reaction vessel was purged with nitrogen. Then, 4 g of potassium persulfate as a polymerization initiator was added thereto and dissolved while the internal temperature was maintained to be 70° C.; and an emulsion preliminarily prepared by adding 20 g of acrylamide, 675 g of styrene, 235 g of butylacrylate, and 30 g of methacrylic acid to 450 g of ion exchanged water and 3 g of sodium lauryl sulfate under stirring was subsequently continuously dropped to the reaction solution over 4 hours. After the dropping, the resulting product was aged over three hours. The resulting aqueous emulsion was cooled to normal temperature, and then ion exchanged water and an aqueous solution of sodium hydroxide were added thereto to adjust the solid content and a pH level to be 40 mass % and 8, respectively. The resulting aqueous emulsion, which served as resin particles 5, had a zeta potential of −10 mV.

### Resin Particles

As resin particles 3, “TAKELAC W6110” (tradename, manufactured by Mitsui Chemicals, Inc.) was prepared. Any of the resin particles 1 to 5 were mixed with ultrapure water such that the solid content was 20 mass %, thereby preparing an aqueous solution 1 of 20 mass % of resin particles. The constitution of the aqueous solution 1 was as follows. As in the preparation of the aqueous solution 1, aqueous solutions 2 to 6 were prepared as follows.

Aqueous solution 1: 20 mass % of any of resin particles 1 to 5 and 80 mass % of ultrapure water

Aqueous solution 2: 90 mass % of any of resin particles 1 to 5 and 10 mass % of ultrapure water

Aqueous solution 3: 20 mass % of any of resin particles 1 to 5, 5 mass % of triethylene glycol monobutyl ether, and 75 mass % of ultrapure water

Aqueous solution 4: 90 mass % of any of resin particles 1 to 5, 5 mass % of triethylene glycol monobutyl ether, and 5 mass % of ultrapure water

Aqueous solution 5: 20 mass % of self-dispersion-type pigment and 80 mass % of ultrapure water

Aqueous solution 6: 90 mass % of self-dispersion-type pigment and 10 mass % of ultrapure water

The aqueous solutions 1, 2, 3, and 4 were each subjected to measurement of volume average particle size D50 with “Microtrac Nanotrac Wave EX150” (tradename, manufactured by MicrotracBEL Corp.), and results of the measurement were defined as the volume average particle sizes D50 ϕ1, ϕ2, ϕ3, and ϕ4 of the resin particles 1 to 5, respectively. Likewise, the volume average particle sizes D50 of the aqueous solutions 5 and 6 were measured, and results of the measurement were defined as the volume average particle sizes D50 ϕ5 and ϕ6 of the self-dispersion-type pigments, respectively. Furthermore, (ϕ2/ϕ1) and (ϕ4/ϕ3) were determined for the resin particles 1 to 5, and (ϕ6/ϕ5) was determined for the self-dispersion-type particles. Tables 2 and 3 show results thereof.

### Materials of Ink Composition and Container

The main components of ink compositions and containers used in production of recorded matters, which will be described later, were as follows.

### Ink Composition

Pigment

Self-dispersion-type carbon black Aqua-Black 162 (registered trademark, manufactured by TOKAI CARBON CO., LTD.)

Resin Particles

Resin particles 1 (resin: styrene acrylic resin)

Resin particles 2 (resin: styrene acrylic resin)

Resin particles 3 [TAKELAC W6110 (tradename, manufactured by Mitsui Chemicals, Inc.), resin: urethane resin]

Resin particles 4 (resin: styrene acrylic resin)

Resin particles 5 (resin: styrene acrylic resin) Organic Solvent

Glycerin

Triethylene glycol monobutyl ether (manufactured by Tokyo Chemical Industry Co., Ltd.)

Surfactant

OLFINE E1010 (tradename, manufactured by Air Products Japan, Inc.)

Surfynol 104PG50 (tradename, manufactured by Nissin Chemical Industry Co., Ltd.)

pH Adjuster

Tri-isopropanolamine

Water

Pure water

Container

Film

Nylon

Polyethylene

Polypropylene

Polyethylene terephthalate

Polyimide

Cellophane

Shape

Shapes illustrated in FIGS. 3 to 5

### Water Absorption Rate

The water absorption rate [%·24 hours] of each of the films was measured in accordance with JIS 7209 (Methods of tests for determining water absorption of plastic and water absorption of boiling water). Specifically, each of the films was immersed in water, and an increase in the mass of the film per unit time was measured. Table 1 shows results of the measurement.

TABLE 1

| Film | Water absorption rate [% · 24 H] |
|---|---|
| Nylon | 1.5 |
| Polyethylene | <0.01 |
| Polypropylene | <0.01 |
| Polyethylene terephthalate | 0.1 |
| Polystyrene | <0.1 |
| Polyimide | 2 |
| Cellophane | 50 |

### Preparation of Ink Composition

Ingredients were mixed in the constitution shown in Tables 2 and 3 and sufficiently stirred to yield ink compositions. In Tables 2 and 3, a unit for the values is mass %, the values each refer to solid content concentration, and the sum of the values is 100.0 mass %.

TABLE 2

| | Example 1 | Example 2 | Example 3 | Example 4 | Example 5 | Example 6 | Example 7 | Example 8 |
|---|---|---|---|---|---|---|---|---|
| Resin Particles 1 | 3.0 | — | — | 0.5 | 5.0 | 3.0 | 3.0 | 3.0 |
| Resin Particles 2 | — | 3.0 | — | — | — | — | — | — |
| Resin Particles 3 | — | — | 3.0 | — | — | — | — | — |
| Resin Particles 4 | — | — | — | — | — | — | — | — |
| Resin Particles 5 | — | — | — | — | — | — | — | — |
| Self-dispersion-type black pigment | 8.0 | 8.0 | 8.0 | 8.0 | 8.0 | 8.0 | 8.0 | 8.0 |
| Glycerin | 20 | 20 | 20 | 20 | 20 | 20 | 20 | 20 |
| Triethylene glycol monobutyl ether | 2.0 | 2.0 | 2.0 | 2.0 | 2.0 | 2.0 | 2.0 | 2.0 |
| OLFINE E1010 | 0.5 | 0.5 | 0.5 | 0.5 | 0.5 | 0.5 | 0.5 | 0.5 |
| Surfynol 104PG50 | 0.5 | 0.5 | 0.5 | 0.5 | 0.5 | 0.5 | 0.5 | 0.5 |
| tri-isopropanolamine | 0.5 | 0.5 | 0.5 | 0.5 | 0.5 | 0.5 | 0.5 | 0.5 |
| Pure water | Balance | Balance | Balance | Balance | Balance | Balance | Balance | Balance |
| Particle size ratio in resin particles (φ2/φ1) | 11 | 5.0 | 10 | 5.0 | 5.0 | 5.0 | 5.0 | 5.0 |
| Particle size ratio in resin particles (φ4/φ3) | 16 | 10 | 18 | 10 | 10 | 10 | 10 | 10 |
| Particle size ratio in self-dispersion-type pigment | 6.0 | 6.0 | 6.0 | 6.0 | 6.0 | 6.0 | 6.0 | 6.0 |
| (φ6/φ5) | | | | | | | | |
| Zeta potential of resin particles [mV] | −23 | −53 | — | −23 | −23 | −23 | −23 | −23 |
| Tg of resin particles [° C.] | −15 | −6.0 | −30 | −15 | −15 | −5.0 | −5.0 | −5.0 |
| Resin for resin particles | Styrene- | Styrene- | Urethane | Styrene- | Styrene- | Styrene- | Styrene- | Styrene- |
| | acrylic | acrylic | | acrylic | acrylic | acrylic | acrylic | acrylic |
| Film material for container | Nylon | Nylon | Nylon | Nylon | Nylon | Nylon | Nylon | Polyethylene |
| Water absorption rate of container [% · 24 H] | 1.5 | 1.5 | 1.5 | 1.5 | 1.5 | 1.5 | 1.5 | <0.01 |
| Shape of container | FIG. 3 | FIG. 3 | FIG. 3 | FIG. 3 | FIG. 3 | FIG. 4 | FIG. 5 | FIG. 4 |
| Fastness of printed matter | A | A | A | B | A | A | A | A |
| Stability of continuous printing | A | A | A | A | B | A | A | A |

TABLE 3

| | | | | Comparative | Comparative | Comparative | Comparative |
|---|---|---|---|---|---|---|---|
| | Example 9 | Example 10 | Example 11 | Example 1 | Example 2 | Example 3 | Example 4 |
| Resin Particles 1 | 3.0 | 3.0 | 3.0 | — | — | — | — |
| Resin Particles 2 | — | — | — | — | — | — | — |
| Resin Particles 3 | — | — | — | — | — | — | — |
| Resin Particles 4 | — | — | — | 3.0 | — | — | — |
| Resin Particles 5 | — | — | — | — | 3.0 | — | 3.0 |
| Self-dispersion-type black pigment | 8.0 | 8.0 | 8.0 | 8.0 | 8.0 | 8.0 | 8.0 |
| Glycerin | 20 | 20 | 20 | 20 | 20 | 20 | 20 |
| Triethylene glycol monobutyl ether | 2.0 | 2.0 | 2.0 | 2.0 | 2.0 | 2.0 | 2.0 |
| OLFINE E1010 | 0.5 | 0.5 | 0.5 | 0.5 | 0.5 | 0.5 | 0.5 |
| Surfynol 104PG50 | 0.5 | 0.5 | 0.5 | 0.5 | 0.5 | 0.5 | 0.5 |
| tri-isopropanolamine | 0.5 | 0.5 | 0.5 | 0.5 | 0.5 | 0.5 | 0.5 |
| Pure water | Balance | Balance | Balance | Balance | Balance | Balance | Balance |
| Particle size ratio in resin | 5.0 | 5.0 | 5.0 | 14 | 13 | — | 13 |
| particles (φ2/φ1) | | | | | | | |
| Particle size ratio in resin | 10 | 10 | 10 | 34 | 26 | — | 26 |
| particles (φ4/φ3) | | | | | | | |
| Particle size ratio in self-dispersion- | 6.0 | 6.0 | 6.0 | 6.0 | 6.0 | 6.0 | 6.0 |
| type pigment (φ6/φ5) | | | | | | | |
| Zeta potential of resin particles [mV] | −23 | −23 | −23 | −5.0 | −10 | — | −10 |
| Tg of resin particles [° C.] | −5.0 | −5.0 | −5.0 | 36 | 50 | — | 50 |
| Resin for resin particles | Styrene-acrylic | Styrene-acrylic | Styrene- | Styrene-acrylic | Styrene-acrylic | — | Styrene-acrylic |
| Film material for container | Polypropylene | Polyethylene | acrylic | Nylon | Nylon | Nylon | Cellophane |
| | | terephthalate | Polyimide | | | | |
| Water absorption rate of | <0.01 | 0.1 | 2 | 1.5 | 1.5 | 1.5 | 50 |
| container [% · 24 H] | | | | | | | |
| Shape of container | FIG. 4 | FIG. 4 | FIG. 4 | FIG. 3 | FIG. 3 | FIG. 3 | FIG. 3 |
| Fastness of printed matter | A | A | A | C | C | D | C |
| Stability of continuous printing | A | A | B | C | B | A | C |

### Stability of Continuous Printing

The ink compositions prepared as described above were individually poured into the containers shown in Tables 2 and 3. The ink compositions were poured to approximately 1/10 of the capacity of each of the containers. Then, the containers containing the ink compositions were left to stand at 60° C. for a week. The resulting containers were individually attached to an ink jet printer (“PX-7050FX”, tradename, manufactured by SEIKO EPSON CORPORATION); then, an initial filling operation was performed, and a nozzle check operation was performed to confirm whether nozzle drop-out occurred or not. An image pattern defined by ISO/IEC 24734 was subsequently continuously printed on 100 sheets of plain paper (Xerox P paper), and then the nozzles were examined to evaluate the stability of continuous printing on the basis of the following criteria. Tables 2 and 3 show results of the evaluation.

### Evaluation Criteria

A: Nozzle drop-out found in less than three nozzles
B: Nozzle drop-out found in three or more but less than five nozzles
C: Nozzle drop-out found in five or more nozzles

### Fastness of Printed Matters

The ink compositions prepared as described above were put in the containers shown in Tables 2 and 3. The containers were individually attached to an ink jet printer (“PX-7050FX”, tradename, manufactured by SEIKO EPSON CORPORATION), and then an image pattern defined by ISO/IEC 24734 was printed on plain paper (Xerox P paper). The printed matter was left to stand at normal temperature and normal humidity for a week, and a line was drawn on the image pattern on the printed matter with a highlighter 300 gf manufactured by ZEBRA CO., LTD. to evaluate the fastness of the printed matter on the basis of the following criteria. Tables 2 and 3 show results of the evaluation.

### Evaluation Criteria

A: Bleeding not observed when a line was drawn twice on the printed image pattern
B: Bleeding not observed when a line was drawn once on the printed image pattern but slightly observed when a line was drawn twice
C: Bleeding not observed when a line was drawn once on the printed image pattern but occurred when a line was drawn twice
D: Bleeding occurred when a line was drawn once on the printed image pattern

The entire disclosure of Japanese Patent Application No. 2017-045096, filed Mar. 9, 2017 is expressly incorporated by reference herein.

What is claimed is:

1. An ink composition comprising:
resin particles;
a pigment;
glycol ether; and
water, wherein
the resin particles satisfy the condition defined by Relational Expression (1)
1.0≤(ϕ2/ϕ1)≤12.5 (1)
(where ϕ1 represents the volume average particle size D50 of the resin particles in a solution containing 20 mass % of the resin particles and 80 mass % of water, and ϕ2 represents the volume average particle size D50 of the resin particles in a solution containing 90 mass % of the resin particles and 10 mass % of water).

2. The ink composition according to claim 1, wherein the resin particles satisfy the condition defined by Relational Expression (2)
1.0≤(ϕ4/ϕ3)≤20 (2)
(where ϕ3 represents the volume average particle size D50 of the resin particles in a solution containing 20 mass % of the resin particles, 5 mass % of triethylene glycol monobutyl ether, and 75 mass % of water; and ϕ4 represents the volume average particle size D50 of the resin particles in a solution containing 90 mass % of the resin particles, 5 mass % of triethylene glycol monobutyl ether, and 5 mass % of water).

3. The ink composition according to claim 1, wherein the pigment is a self-dispersion-type pigment that satisfies the condition defined by Relational Expression (3)
1.0≤(ϕ6/ϕ5)≤10 (3)
(where ϕ5 represents the volume average particle size D50 of the self-dispersion-type pigment in a solution containing 20 mass % of the self-dispersion-type pigment and 80 mass % of water, and ϕ6 represents the volume average particle size D50 of the self-dispersion-type pigment in a solution containing 90 mass % of the self-dispersion-type pigment and 10 mass % of water).

4. The ink composition according to claim 1, wherein the glass transition temperature of the resin particles is from −50° C. to 0° C.

5. The ink composition according to claim 1, wherein the resin particles contain at least one selected from the group consisting of a (meth)acrylic resin, a urethane resin, an epoxy resin, a polyolefin resin, and a styrene acrylic resin.

6. The ink composition according to claim 1, wherein the resin particle content is from 0.5 mass % to 5.0 mass % relative to the total amount of the ink composition.

7. The ink composition according to claim 1, wherein the pigment is a carbon black pigment subjected to an ozone oxidation treatment.

8. The ink composition according to claim 1, wherein the zeta potential of the resin particles is from −60 mV to −15 mV in a solution containing 20 mass % of the resin particles and 80 mass % of water.

9. A container comprising:
a containing portion formed of a flexible film; and
the ink composition according to claim 1, the ink composition being contained in the containing portion, wherein
the water absorption rate of the film is 3% or less.

10. A container comprising:
a containing portion formed of a flexible film; and
the ink composition according to claim 2, the ink composition being contained in the containing portion, wherein
the water absorption rate of the film is 3% or less.

11. A container comprising:
a containing portion formed of a flexible film; and
the ink composition according to claim 3, the ink composition being contained in the containing portion, wherein
the water absorption rate of the film is 3% or less.

12. A container comprising:
a containing portion formed of a flexible film; and
the ink composition according to claim 4, the ink composition being contained in the containing portion, wherein
the water absorption rate of the film is 3% or less.

13. A container comprising:
a containing portion formed of a flexible film; and
the ink composition according to claim 5, the ink composition being contained in the containing portion, wherein
the water absorption rate of the film is 3% or less.

14. A container comprising:
a containing portion formed of a flexible film; and
the ink composition according to claim 6, the ink composition being contained in the containing portion, wherein
the water absorption rate of the film is 3% or less.

15. A container comprising:
a containing portion formed of a flexible film; and
the ink composition according to claim 7, the ink composition being contained in the containing portion, wherein
the water absorption rate of the film is 3% or less.

16. A container comprising:
a containing portion formed of a flexible film; and
the ink composition according to claim 8, the ink composition being contained in the containing portion, wherein
the water absorption rate of the film is 3% or less.

17. The container according to claim 9, wherein the film has two or more layers, and the two or more layers at least include a layer containing nylon.

18. The container according to claim 10, wherein the film has two or more layers, and the two or more layers at least include a layer containing nylon.

19. The container according to claim 11, wherein the film has two or more layers, and the two or more layers at least include a layer containing nylon.

20. The container according to claim 12, wherein the film has two or more layers, and the two or more layers at least include a layer containing nylon.
